(19) United States
(12) Patent Application Publication
(10) Pub. No.: US 2003/0091377 A1
(43) Pub. Date: May 15, 2003

(54) Input apparatus and method

(76) Inventors: Chia-Chang Hsu, Hsinchu (TW); Chi-Fang Ma, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/287,124

(22) Filed: Nov. 4, 2002

(30) Foreign Application Priority Data
Nov. 9, 2001 (TW) 090127964

(51) Int. Cl. B41J 5/12

(52) U.S. Cl. 400/472

(57) ABSTRACT

An input apparatus and method for use in an information input unit. The information input unit is coupled to an information device having a display. The input apparatus includes an operational selection module, which is coupled to the information input unit, for generating a press signal in response to a pressing operation detected by the operational selection module and for generating a shift signal in response to a shifting operation detected by the operational selection module. A control chip of the information input unit activates the information device to display a graphical interface indicative of a set of options on the display when the information input unit receives the shift signal. Selection of the set of options on the graphical interface is made according to the press signal and the shift signal.

This application incorporates by reference Taiwan application Serial No. 090127964, filed Nov. 9, 2001.

### BACKGROUND OF THE INVENTION

1. Field of the Invention

The invention relates in general to an input apparatus and method, and more particularly to an input apparatus and method using a graphic interface generated by an information device.

2. Description of the Related Art

FIG. 1 is a conventional keyboard 100. Function keys, such as the keys for getting access to the Internet, receiving and transmitting e-mails, adjusting audio volume, and playing multimedia files, are added on the keyboard 100 for the user's convenience. The operation of each function key includes the following steps. First, a scan code is generated when a user presses and then releases a function key. An interrupt service routine is then executed in response to the scan code. Finally, a corresponding application program is activated to execute the specified function of the function key. The procedure to start up an application program with a function key in this way is simpler than that in which the user has to use the mouse or keyboard conventionally for performing selection in a user graphic interface (GUI).

Take the personal computer for example. When a function key of the keyboard 100 is pressed, an electrical signal, 24 bits for example, is outputted to a keyboard controller and then a QIRQ1 signal is outputted by the keyboard controller according to a predetermined map table. The QIRQ1 signal triggers the interrupt controller of the south bridge (SB) at the IRQ1 pin of the SB by a leakage-proof circuit and a pull-high circuit. The interrupt controller thus outputs an INTR signal to trigger the central processing unit (CPU) at the INTR pin of the CPU. Then, the CPU interrupts the currently executed program, saves the necessary information of the program and the program counter to the stack, and outputs a PCI special cycle as a response to the interrupt controller via the north bridge, PCI bus, and the PCI bus interface. After receiving the response from the CPU, the interrupt controller outputs an interrupt vector index, such as INT 09H, to the CPU. This interrupt vector index representing the IRQ1 is transmitted to the CPU via the PCI bus and the north bridge. The CPU multiplies the value of the interrupt vector index by 4 to obtain the address of the corresponding interrupt service routine, such as 24H-27H. The CPU searches the interrupt vector table for the address of the interrupt service routine according to the interrupt vector index and then jumps to the address of the interrupt service routine for execution. The interrupt service routine reads the scan code at a port, e.g. 60H, and accordingly performs the specified function. When the interrupt service routine finishes, the CPU retrieves the program counter and all the necessary information from the stack.

The function keys, as indicated above, are conveniences to activate specific tasks for users. However, the function keys with individual functions disposed in one keyboard may cause some users to easily confuse one function with other ones. Further, the additional function keys occupy the keyboard's space that would increase its area and thus increase the hardware cost. Therefore, a new approach to providing these conveniences is needed with desirable effects.

### SUMMARY OF THE INVENTION

It is therefore an object of the invention to provide an input apparatus for use in an information input unit. The information input unit is coupled to an information device having a display. The input apparatus includes an operational selection module. The operational selection module is coupled to the information input unit, for generating a press signal in response to a pressing operation detected by the operational selection module and for generating a shift signal in response to a shifting operation detected by the operational selection module. A control chip of the information input unit activates the information device to display a graphical interface indicative of a set of options on the display when the information input unit receives the shift signal. Selection of the set of options on the graphical interface is made according to the press signal and the shift signal.

It is therefore another object of the invention to provide an input method for controlling an operational selection module of an information input unit. The information input unit is coupled to an information device having a display. The input method includes the following steps. First, in response to a shifting operation, the operational selection module outputs a shift signal to the information input unit. The information device is then activated by a control chip of the information unit to generate a graphic interface, which having a set of options. Second, in response to the shifting operation, the operational selection module outputs the shift signal to the information input unit. Accordingly, the information device controls the selection of the set of options on the graphic interface. Next, in response to a pressing operation, the operational selection module outputs a press signal to the information input unit, and accordingly the information device executs the selected option.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a conventional keyboard.

FIG. 2 is a block diagram of an input apparatus 200 according to the embodiment of the invention.

FIG. 3 is a block diagram of the input apparatus.

FIG. 4 illustrates the connection between the input apparatus and the information input unit.

FIG. 5 illustrates signal transmission among the input apparatus 200, information input unit 201 and the information device 202.

FIG. 6 is a diagram of the information device.

FIG. 7 is a flow chart of a control method for the input apparatus.

FIG. 8 is a block diagram illustrating a computer keyboard unit according to the invention.

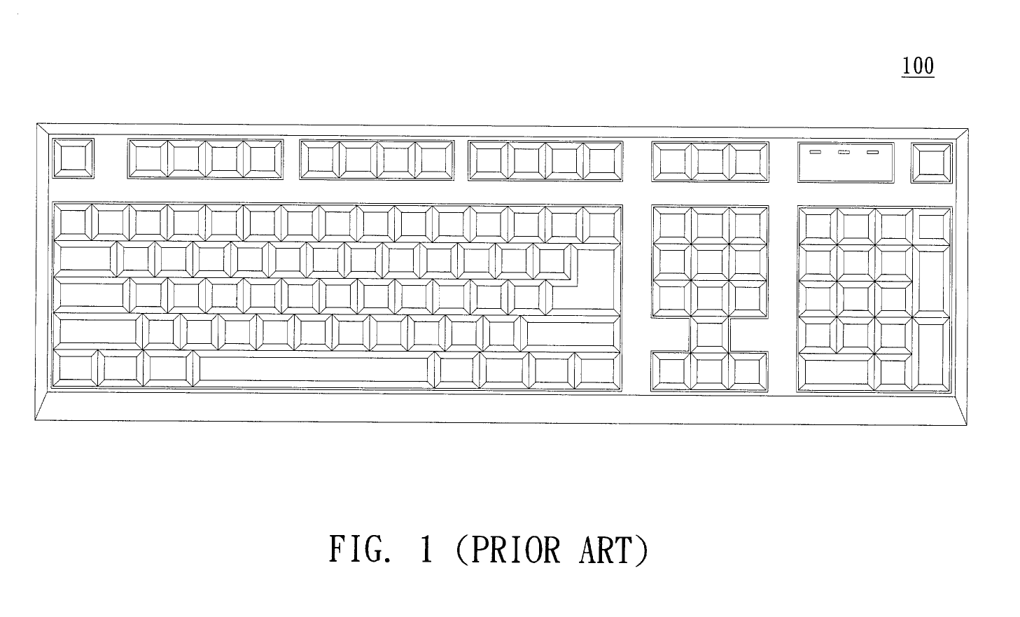

### DETAILED DESCRIPTION OF THE INVENTION

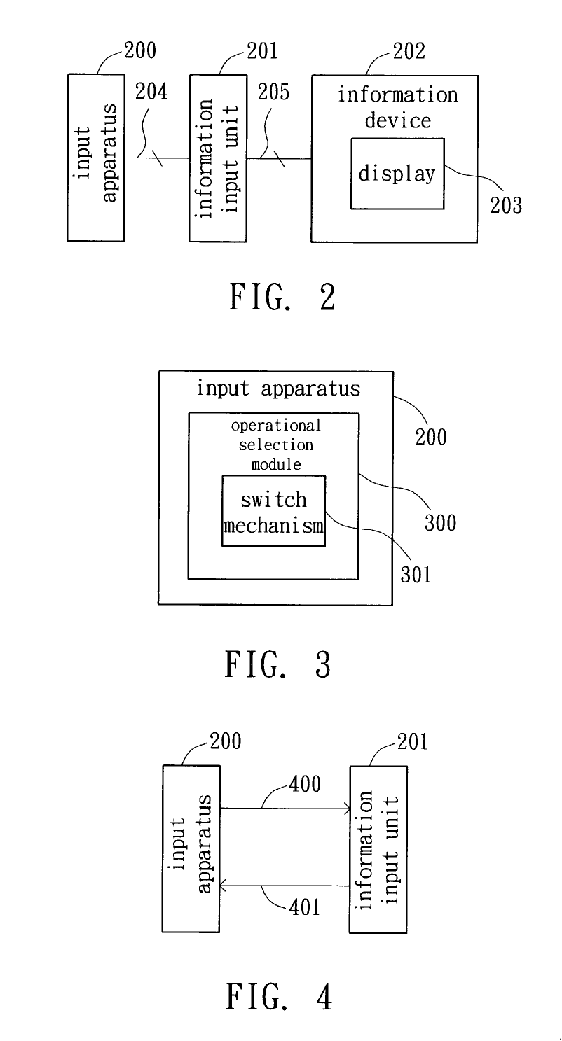

FIG. 2 is a block diagram of an input apparatus 200 according to the embodiment of the invention. The input apparatus 200 is coupled to an information input unit 201 by a connection cable 204. The information input unit 201 is a keyboard controller, for example. The information input unit 201 is coupled to an information device 202, which has a display, by wire or wireless approach, such as by a connection line 205 in this embodiment. The information device 202 is a computer or a personal digital assistant (PDA), for example.

FIG. 3 is a block diagram of the input apparatus 200. The input apparatus 200 includes at least an operational selection module 300. The operational selection module 300 includes a switch mechanism 301 for detecting the user's operation, such as pressing and shifting, and then accordingly determine the position of the pointer on the display. The function of shifting includes up, down, left, right, clock-wise rotation, and counter-clock-wise rotation. FIG. 4 illustrates the connection between the input apparatus 200 and the information input unit 201. The input apparatus 200 outputs a press signal 400 and a shift signal 401 to information input unit 201 by connection line 204 according to the user's operation of pressing and shifting, respectively.

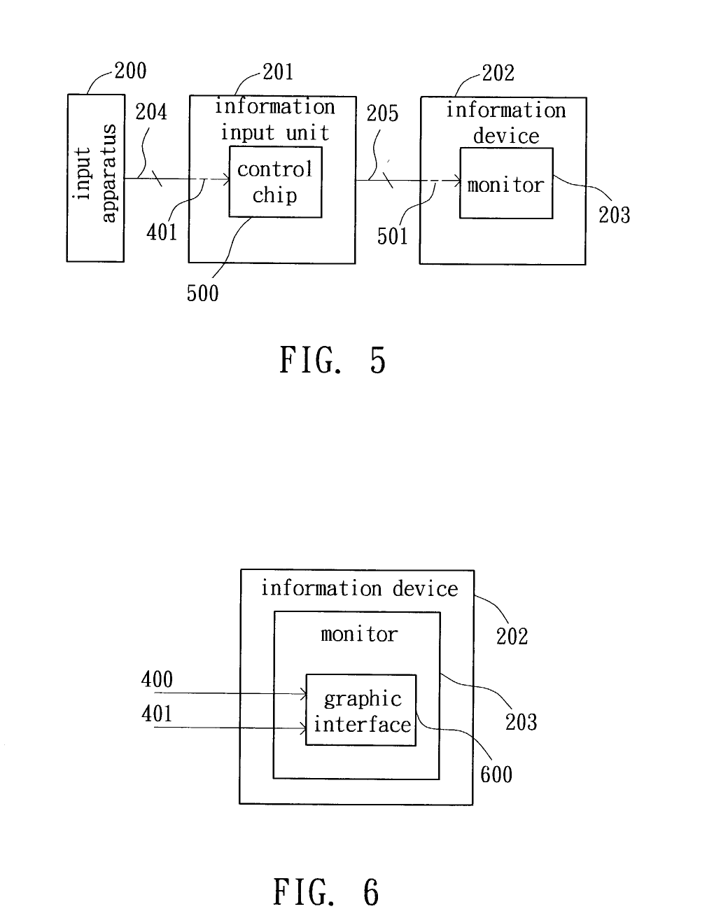

FIG. 5 illustrates signal transmission among the input apparatus 200, information input unit 201 and the information device 202. When the information input unit 201 receives the shift signal 401, a control chip 500 of the information input unit 201 accordingly outputs a driving signal 501 to the information device 202. Therefore, a graphic interface 600 is generated by the information device 202 on the display 203, as shown in FIG. 6. The invention is to provide a way of selection from the graphic interface 600, showing a list of tasks, by using the input apparatus so as to activate a task.

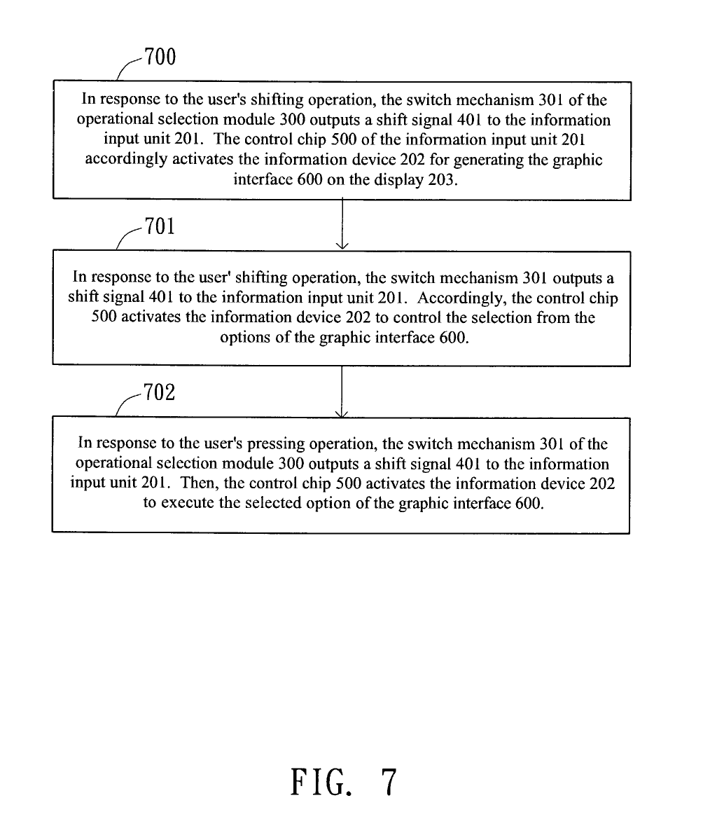

FIG. 7 is a flow chart of a control method for the input apparatus 200. First, as shown in step 700, in response to the user's shifting operation, the switch mechanism 301 of the operational selection module 300 outputs a shift signal 401 to the information input unit 201. The control chip 500 of the information input unit 201 accordingly activates the information device 202 for generating the graphic interface 600 on the display 203. Then, as shown in step 701, in response to the user' shifting operation, the switch mechanism 301 outputs a shift signal 401 to the information input unit 201. Accordingly, the control chip 500 activates the information device 202 to control the selection from the options of the graphic interface 600. In step 702, in response to the user's pressing operation, the switch mechanism 301 of the operational selection module 300 outputs a shift signal 401 to the information input unit 201. Then, the control chip 500 activates the information device 202 to execute the selected option of the graphic interface 600.

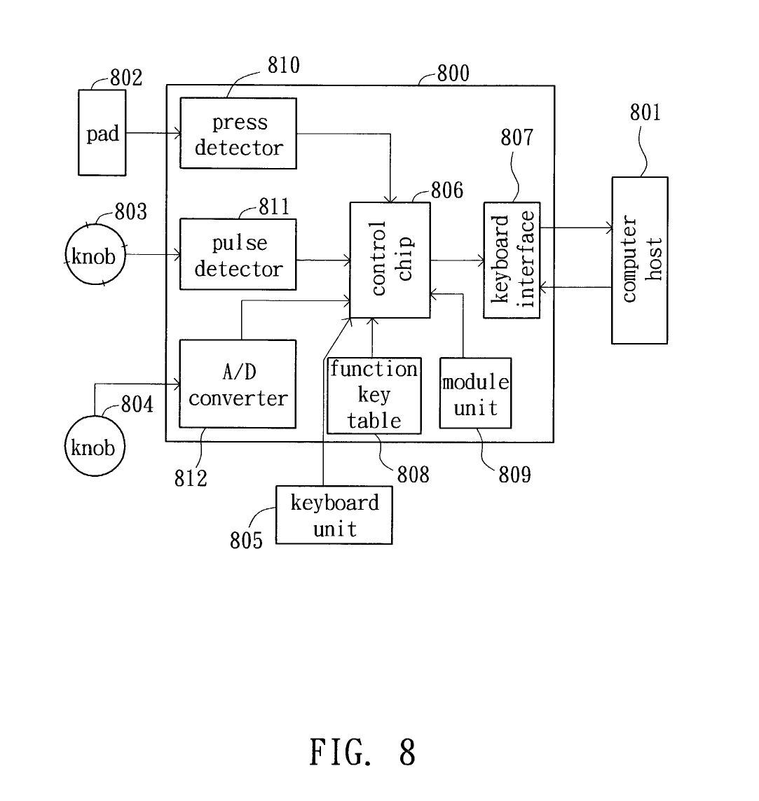

FIG. 8 is a block diagram illustrating a computer keyboard unit according to the invention. The system includes a computer keyboard process unit 800, a keyboard 805, a scaled knob 803, a non-scaled knob 804, a cursor pad 802 and a computer host 801. The computer keyboard process unit 800 includes a control chip 806, a keyboard interface 807, a function key table 808, a module unit 809, a press detector 810, a pulse detector 811 and an analog-to-digital (A/D) converter converter. The knobs 803, 804 and the cursor pad 802 are coupled to the control chip 806 via the pulse detector 811, the A/D converter 812, and the press detector 810, respectively. The keyboard unit 805, the function key table 808, and the module unit 809 are coupled to the control chip 806. The control chip 806 is coupled to the computer host 801 via the keyboard interface 807. The operations of the knobs 804, 804 and the cursor pad 802 are described respectively in detail in the following paragraphs.

While the scaled knob 803 is pressed, clockwise rotated, or counterclockwise rotated, the pulse detector 811 accordingly generates a single pulse or a series of pulses to the control chip 806. The phase of the pulse according to the clock-wise rotation of the knob 803 is different from the pulse according to the counter-clock-wise rotation. Therefore, the control chip 806 determines the direction of the rotation of the knob 803 by the phase of the pulse, outputs an interrupt signal to the computer host 801, and then accordingly outputs the interrupt vector index and the scan code to the computer host 801 by the keyboard interface 807. Then, the computer host 801 executes the correspondent interrupt service routine according to the interrupt vector index after receiving the scan code and the interrupt vector. The interrupt service routine is, for example, the WINExec 0 function supplied by the Microsoft Windows operating system, and the parameters of the WINExec 0 function are the name and the path of the correspondent application, which shows the graphic interface and control the selection of the options on the graphic interface. There is a cursor indicator shown on the graphic interface according to the user's operation at the knob 803. The user can move the cursor indicator to the position of the desired option on the graphic interface 600 by controlling the knob 803 and then press the knob to execute that option. The graphic interface will disappear if the user does not use the knob for a predetermined time, about 2 to 3 seconds.

If the non-scaled knob 804 is pressed, clock-wise rotated, or counter-clock-wise rotated, the on-scaled knob 804 outputs an analog signal to the A/D converter, which then outputs a digital signal to the control chip 806. Then, the control chip 806 determines the direction of the rotation of the knob 803 by the digital signal, and outputs a corresponding scan code to the keyboard interface 807. Then, the keyboard interface 807 outputs an interrupt signal, the corresponding interrupt vector index and the scan code to the computer host 801. The computer host 801 executes the interrupt service routine according to the interrupt vector index after receiving the scan code and the interrupt vector index. The interrupt service routine is, for example, the WINExec 0 function provided by the Microsoft Windows operating system, and the parameters of the WINExec 0 function are the name and the path of the correspondent application, which shows the graphic interface 600 and control the selection of the options on the graphic interface 600. A cursor indicator is shown on the graphic interface according to the user's operation at the knob 803. The user can move the cursor indicator to the desired option on the graphic interface by controlling the knob 803 and then press the knob 803 to execute. The graphic interface will disappear if the user does not use the knob for a predetermined time, about 2 to 3 seconds.

The cursor pad 802 can be pressed upward, downward, to the left, or right. If the cursor pad 802 is pressed, the press detector 810 generates a single pulse or a series of pulses to the control chip 806 accordingly. The phases of the pulses of different directions are different. Therefore, the control chip 806 determines the pressed direction of the cursor pad 802 by the phase of the pulse, and outputs a corresponding scan code to the keyboard interface 807 according to the function key table 808. Then, the keyboard interface 807 outputs an interrupt signal, the corresponding interrupt vector index and the scan code to the computer host 801. The computer host 801 executes the correspondent interrupt service routine according to the interrupt vector index after receiving the scan code and the interrupt vector index. The interrupt service routine is, for example, the WINExec 0 function supplied by the Microsoft Windows operating system, and the parameters of the WINExec 0 function are the name and the path of the correspondent application, which shows the graphic interface. There is an cursor indicator shown on the graphic interface according to the user's operation at the knob 803. The user can move the inverse light spot to the position of the desired option on the graphic interface by controlling the knob 803 and then press the knob to execute that option. The graphic interface will disappear if the user does not use the knob for a predetermined time, about 2 to 3 seconds.

The module unit 809 is used for switching the input source of the control chip 806 to be one or multiple of the keyboard unit 805, the knobs 803, 804, and the cursor pad 802.

The knobs 803, 804 and the cursor pad 802 can be implemented on the upper side of the number keypad of the keyboard unit 806 for easy usage. The user can control the scaled, no-scale knob, or the cursor pad to execute an option on the graphic interface, which replaces the function of the conventional function key.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An input apparatus for use in an information input unit, the information input unit being coupled to an information device having a display, the input apparatus comprising:
an operational selection module, coupled to the information input unit, for generating a press signal in response to a pressing operation detected by the operational selection module and for generating a shift signal in response to a shifting operation detected by the operational selection module;
wherein a control chip of the information input unit activates the information device to display a graphical interface indicative of a set of options on the display when the information input unit receives the shift signal, and selection of the set of options on the graphical interface is made according to the press signal and the shift signal.

2. The input apparatus according to claim 1, wherein the information input unit is a keyboard controller.

3. The input apparatus according to claim 1, wherein the information input unit is coupled to a keyboard.

4. The input apparatus according to claim 1, wherein the operational selection module comprises a switch mechanism.

5. The input apparatus according to claim 4, wherein the switch mechanism is a cursor pad.

6. The input apparatus according to claim 4, wherein the switch mechanism is a knob.

7. The input apparatus according to claim 5, wherein the cursor pad outputs the press signal and the shift signal to the control chip by a press detector.

8. The input apparatus according to claim 6, wherein the knob outputs the press signal and the shift signal to the control chip by a pulse detector.

9. The input apparatus according to claim 6, wherein the knob outputs the press signal and the shift signal to the control chip by an analog-to-digital converter.

10. The input apparatus according to claim 7, wherein the press detector is comprised in the information input unit.

11. The input apparatus according to claim 8, wherein the pulse detector is comprised in the information input unit.

12. The input apparatus according to claim 9, wherein the analog-to-digital converter is comprised in the information input unit. The input apparatus according to claim 1, wherein the control chip drives the information device by a keyboard interface.

13. The input apparatus according to claim 12, wherein the keyboard interface is comprised in the information input unit, and outputs an interrupt vector and a scan code to the information input unit.

14. The input apparatus according to claim 13, wherein the selection of the set of options on the graphic interface is according to the interrupt vector and the scan code.

15. The input apparatus according to claim 1, wherein the shifting operation comprises shifting and rotation.

16. The input apparatus according to claim 15, wherein the shifting comprises upward, downward, left and right.

17. The input apparatus according to claim 15, wherein the rotation comprises clock-wise rotation and counter-clock-wise rotation.

18. An input method for controlling an operational selection module of an information input unit, the information input unit being coupled to an information devicehaving a display, the input method comprising:
in response to a shifting operation, the operational selection module outputting a shift signal to the information input unit, the information device being activated by a control chip of the information unit to generate a graphic interface, which having a set of options;
in response to the shifting operation, the operational selection module outputting the shift signal to the information input unit, and accordingly the information device controlling a selection of the set of options on the graphic interface; and in response to a pressing operation, the operational selection module outputting a press signal to the information input unit, and accordingly the information device executing the selected option.

19. The input apparatus according to claim 18, wherein the information input unit is a keyboard controller.

20. The input apparatus according to claim 18, wherein the information input unit is coupled to a keyboard.

21. The input apparatus according to claim 18, wherein the operational selection module comprises a switch mechanism.

22. The input apparatus according to claim 21, wherein the switch mechanism is a cursor pad.

23. The input apparatus according to claim 21, wherein the switch mechanism is a knob.

24. The input apparatus according to claim 22, wherein the cursor pad outputs the press signal and the shift signal to the control chip by a press detector.

25. The input apparatus according to claim 23, wherein the knob outputs the press signal and the shift signal to the control chip by a pulse detector.

26. The input apparatus according to claim 23, wherein the knob outputs the press signal and the shift signal to the control chip by an analog-to-digital converter.

27. The input apparatus according to claim 24, wherein the press detector is comprised in the information input unit.

28. The input apparatus according to claim 25, wherein the pulse detector is comprised in the information input unit.

29. The input apparatus according to claim 26, wherein the analog-to-digital converter is comprised in the information input unit.

30. The input apparatus according to claim 18, wherein the control chip drives the information device by a keyboard interface.

31. The input apparatus according to claim 29, wherein the keyboard interface is comprised in the information input unit, and outputs an interrupt vector and a scan code to the information input unit.

32. The input apparatus according to claim 18, wherein the selection of the set of options on the graphic interface is according to the interrupt vector and the scan code.

33. The input apparatus according to claim 32, wherein the shifting operation comprises shifting and rotation.

34. The input apparatus according to claim 33, wherein the shifting comprises upward, downward, left and right.

35. The input apparatus according to claim 33, wherein the rotation comprises clock-wise rotation and counter-clock-wise rotation.
